(19) United States
(12) Patent Application Publication
(10) Pub. No.: US 2017/0160707 A1
(43) Pub. Date: Jun. 8, 2017

(54) METHOD AND APPARATUS FOR ADJUSTING THERMAL THRESHOLDS

(71) Applicant: INTEL CORPORATION, Santa Clara, CA (US)

(72) Inventor: Vasudevan SRINIVASAN, Hillsboro, OR (US)

(73) Assignee: Intel Corporation

(21) Appl. No.: 14/958,424

(22) Filed: Dec. 3, 2015

(51) Int. Cl. G05B 15/02; G05D 23/19; G05B 19/042

(52) U.S. Cl. CPC G05B 15/02; G05B 19/0428; G05D 23/19; G05B 2219/49217

(57) ABSTRACT

An electronic device may perform thermal management operations. The electronic device may receive thermal rating information, and determine an adjusted thermal threshold based on a previous temperature threshold and the thermal rating information. The electronic device may further store the adjusted thermal threshold, and control performance of the electronic device based on the adjusted thermal threshold.

### BACKGROUND

1. Field

Embodiments may relate to adjusting a thermal threshold of an electronic device.

2. Background

Performance and capabilities of electronic devices have increased rapidly in recent years. Many electronic devices may include one or more processors, memory, wireless connectivity and other heat generating components.

### BRIEF DESCRIPTION OF THE DRAWINGS

Arrangements and embodiments may be described in detail with reference to the following drawings in which like reference numerals refer to like elements and wherein:

FIG. 1 is a block diagram of an electronic device according to an example embodiment;

FIG. 2 shows an electronic device having a protective cover according to an example arrangement;

FIG. 3 shows an electronic device that displays a request for thermal rating information according to an example embodiment;

FIG. 4 is a flowchart of operations according to an example embodiment; and

FIG. 5 is a diagram of an electronic system according to an example embodiment.

### DETAILED DESCRIPTION

Any reference to “one embodiment” or “an embodiment” means that a particular feature, structure, or characteristic described in connection with the embodiment is included in at least one embodiment. The appearances of the phrases “in one embodiment” and “in an embodiment” in various places in the specification are not necessarily all referring to the same embodiment. Further, different embodiments may be combined with other embodiments.

Embodiments may relate to electronic devices, such as tablet computers, handheld computing devices, smartphones, laptop computers and netbook computers, for example. Electronic devices may require effective cooling elements to prevent overheating of system components and also to reduce heat transferred to a chassis of the electronic device.

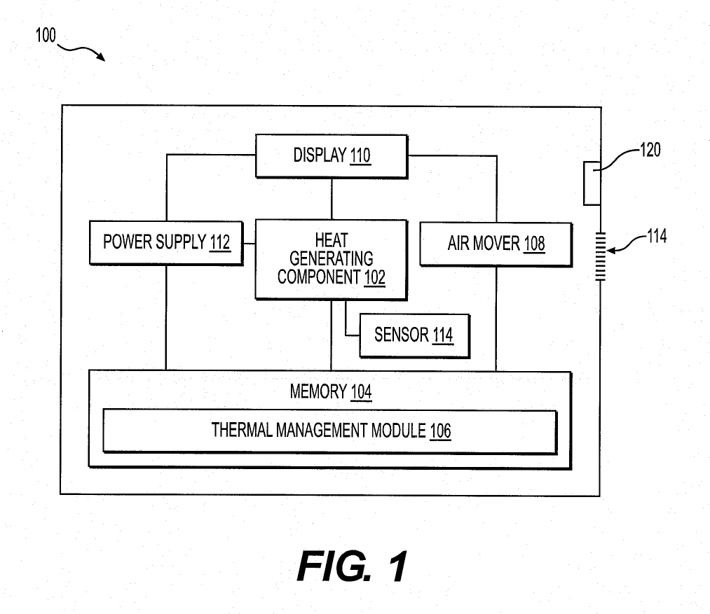

FIG. 1 is a block diagram of an electronic device according to an example embodiment. Other embodiments and configurations may also be provided.

FIG. 1 shows an electronic device 100 that may include a tablet computer, handheld computer, personal digital assistant (PDA), cellular telephone, combination cellular telephone/PDA, smartphone, laptop computer, ultra-laptop computer, portable computer, personal computer (PC), notebook PC, netbook, pager, messaging device, media player, digital music player, and/or etc. For ease of discussion, arrangements and embodiments may be described hereafter with respect to a smartphone.

The electronic device 100 may include various electronic components such as a heat generating component 102, a memory 104, a thermal management module 106, an air mover 108, a display 110, a power supply 112, a sensor 114 and a key 120. Other components may also be provided.

The key 120 may be a button on a side or the electronic device or a front surface of the electronic device 100. The key 120 may also be a soft key on the display 110.

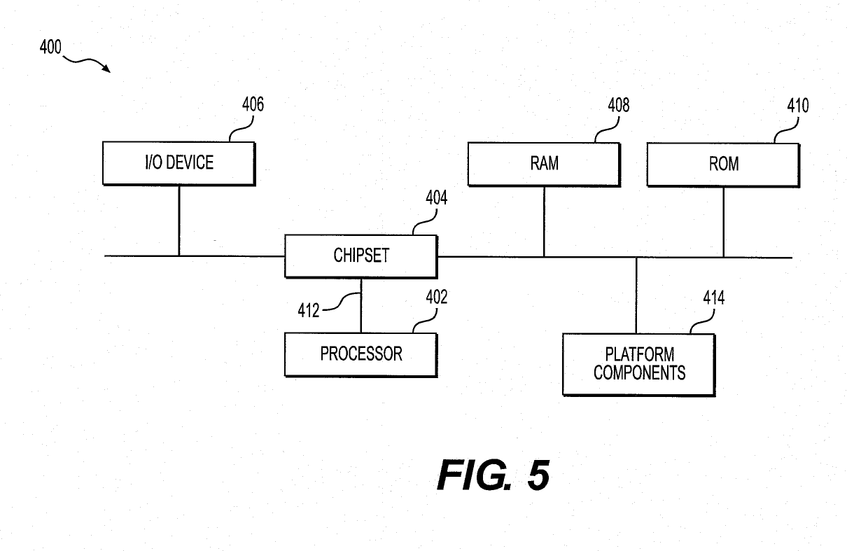

While FIG. 1 shows a limited number and arrangement of components for purposes of illustration, the electronic device 100 may include any number or arrangement of components. Additional components may be discussed in further detail below with reference to FIG. 5.

The heat generating component 102 may include any suitable electric device, a semiconductor device, a system on chip and/or other component capable of generating heat. For example, the heat generating components 102 may include a processor, a multi-core processor, a controller and/or one or more radio modules or combination transmitter/receiver (e.g. transceiver) devices.

The memory 104 may include any suitable physical device operative to store data, programs, sequences of instructions or other information on a temporary or permanent basis for use in the electronic device 100. For example, the memory 104 may include volatile or non-volatile memory, random access memory (RAM), read only memory (ROM), virtual memory and/or a hard disc drive, for example.

The thermal management module 106 may include software, firmware, hardware or any suitable combination of software, firmware or hardware. The thermal management module 106 may include logic stored in the memory 104 to be executed by a processor to perform thermal management operations. The processor may correspond to (or be part of) the heat generating component 102. The thermal management module 106 may include firmware or an embedded controller implemented in an operating system of the electronic device 100. While shown as part of the memory 104 in FIG. 1, the thermal management module 106 may be implemented anywhere within the electronic device 100 and still fall within the described embodiments. For ease of description, the thermal management module may include the processor performing thermal management operations.

The air mover 108 may be an optional component. As one example, the air mover 108 may be provided in a tablet, phone, etc. The air mover 108 may include any suitable device capable of creating a flow of air. For example, the air mover 108 may include a fan or a blower arranged to generate a flow of air in the electronic device 100. The air mover 108 may include a rotating arrangement of vanes or blades that act on the air to generate an airflow or may include a fan wheel composed of a number of fan blades or ribs mounted around a hub to generate a flow of air. A vent 114 may be provided adjacent to the air mover 108.

The display 110 may include any suitable visual interface for displaying content to a user of the electronic device 100. The display 110 may be implemented by a liquid crystal display (LCD) or a touch-sensitive color LCD screen. The touch-sensitive LCD may be used with a stylus and/or a handwriting recognizer program. The display 110 may include a digital touchscreen display (or touchscreen) arranged to occupy a substantial portion of the electronic device 100. As described hereafter, the display 110 may be a touchscreen.

The power supply 112 may include any device suitable for providing electrical power to the electronic device 100. For example, the power supply 112 may include an alternate current (AC) power supply or a direct current (DC) power supply. The power supply 112 may include a battery or other energy storage device capable of storing and providing power to the electronic device 100.

The vent 114 may be provided adjacent to the air mover 108. The vent 114 may include any opening, slot or other arrangement of the electronic device 100 that allows air to enter the electronic device 100 or to allow air to exit the electronic device 100. The vent may be arranged to allow airflow to enter the electronic device 100 to cool internal components of device, such as the heat generating component 102.

The thermal management operations may monitor one or more parameters of the electronic device 100. For example, the one or more parameters may include temperature of a chassis of the electronic device 100 at various locations. The chassis temperatures may be monitored using direct or indirect mechanisms such as sensors embedded on the chassis or on a motherboard of the electronic device. Thermal management operations may also monitor other environmental factors that may affect user experience such as environmental pressure, altitude changes, location of the device itself, etc. Thermal management operations may also monitor speed, revolutions per minute (RPM), voltage, pulse width modulation (PWM) or any other suitable parameter of the air mover 108. As one example, the air mover 108 may include a fan or a blower, and the one or more parameters may include a speed of the fan or blower or a voltage of the fan or blower.

The thermal management operations may determine if changes have occurred in the one or more parameters of the electronic device, and the thermal management operations may take an appropriate action based on the detected changes. For example, the thermal management operations may determine or may retrieve a pre-determined baseline parameter for a temperature sensor, such as the proxy temperature for the chassis. The thermal management operations may continuously or periodically check the temperature and compare this to the target temperature limit. This comparison may indicate that the temperature of the chassis has reached or crossed the limit for the specific sensor.

The thermal management operations may perform one or more thermal management operations based on changes in one or more parameters of the electronic device. The thermal management operations may be performed based on the changing of any one of a plurality of parameters of the electronic device 100.

The thermal management operations may include generating a user notification regarding changes to the component or parameter. The user notification may include a visual notification, a touch notification and/or an audio notification. The notification may be presented to a user to alert that a change has occurred for the electronic device 100. The user notification may include information regarding the change and/or a suggested action to remedy the change.

The thermal management operations may include controlling a performance of an electronic component of the electronic device 100. The controlling of the performance may include performing thermal management by turning on an electronic component (or powering an electronic component). This may include activating a fan within the electronic device. More sophisticated responses may also be provided in some embodiments. For example, the thermal management schemes may rely on system level calibrations to determine a most efficient throttling scenario for any given workload demand.

The thermal management operations (as part of the thermal management module) may be originally provided by an original equipment manufacturer (OEM) or other manufacturer. The thermal management operations may be provided within the electronic device prior to an end user receiving the electronic device 100. The thermal management operations may be provided within the memory 104, for example.

The thermal management operations may optimize thermal designs by using both hardware thermal solutions as well as software based thermal management algorithms. Intel Dynamic Platform and Thermal Framework (Intel DPTF) is one solution for managing thermals to target specific design goals.

Thermal designs may target a specific user comfort level while using the electronic device so as to ensure that usage of the electronic device does not cross that comfort level. Embodiments may provide a mechanism for a user to input a specific comfort level to augment a target design (such as an OEM design target).

The thermal management operations may optimize thermal solutions by targeting specific parameters. As one example, the thermal management operation may provide a skin temperature threshold (or limit) for the electronic device based on a temperature of the electronic device while the electronic device is operating. The skin temperature threshold (or limit) is a value that provides a specific thermal design.

As one example, the thermal management operations may control components of the electronic device based on a skin temperature threshold. For example, when the skin temperature threshold is reached, then a specific action may occur to reduce the actual temperature.

The skin temperature threshold may be determined based on a chassis temperature of the operating electronic device and based on a previously determined difference value. The temperature of the electronic device may be determined based on the sensor 114 in the electronic device 100.

Based on previously determined experiments and/or data, the previously determined difference value may be a 25° C. difference between a sensed temperature and a skin temperature. This 25° C. difference is merely one difference value that may hereafter be used. However, other difference values may also be used.

The thermal management operations may determine the skin temperature by subtracting the 25° C. difference value from the sensed temperature (determined by the sensor 114). The thermal management operations may thereby calculate the skin temperature.

The thermal management operations may provide uniform operations for similar electronic devices. The thermal management operations may be based on similar parameters of the electronic device. The thermal management operations are previously stored in the electronic device. However, the thermal management operations do not factor different properties or parameters between similar electronic devices.

As one example, users may individually protect smartphones and tablets against damage by providing a protective cover or screen protector on their respective electronic device. However, each user may use a different type of protective cover or screen protector. The thermal management operations do not factor different properties or parameters of different protective covers (or screen protectors) for the electronic device.

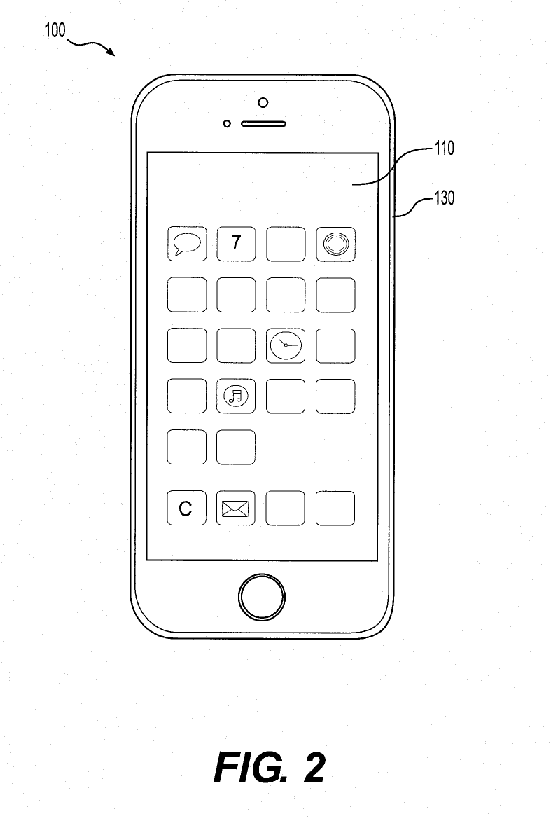

FIG. 2 shows an electronic device having a protective cover according to an example arrangement. Other arrangements may also be provided.

FIG. 2 shows the electronic device 100 having the display 110 on an outside surface of the electronic device 100. A protective cover 130 may be provided about a majority of the electronic device 100 while still exposing the display 110. The cover 130 may serve several purposes, including protecting the electronic device when the device is dropped and/or protecting the electronic device from water. The cover may serve other purposes. On the other hand, the cover 130 may inhibit heat (from components of the electronic device) from exiting the electronic device. This may affect thermal management operations which do not anticipate specific restrictions for heat to exit the electronic device.

Different users may use different types of covers (or other protective means). This may affect the thermal management operations in different ways. Unfortunately, the OEM that provide the specific thermal management operations is unaware of the specific protective cover that may be used by an end user. Embodiments may allow a user to safely override a thermal target (or performance target) of an electronic device.

Embodiments may provide a user interface for a user to intuitively change at least one thermal threshold (or thermal management design target). The user interface may be an application that is executed on the electronic device, or a methodology that is performed by the electronic device. The user interface may be a graphic user interface (GUI) application or may be a button that a user may press.

The user interface may be provided at the electronic device to communicate user thermal comfort information such that the thermal management operations may adjust at least one thermal threshold based on the input from the user. As one example, the thermal comfort information may be thermal rating information. The electronic device may thereby have better performance than originally intended by taking advantage of the user input based on the actual operating environment. The electronic device may have better performance while not violating user comfort requirements.

The electronic device 100 may include the sensor 114, such as a thermal sensor, to determine a temperature. As one example, the sensor 114 may determine the temperature of the electronic device to be 70° C. The thermal management operation (or system) may thereby calculate the skin temperature to be 45° C. (70° C.−25° C.=45° C.). This calculation is based on a previously stored algorithm and/or data. This value of 45° C. may be used for thermal control of the electronic device.

However, a protective cover (or other protection device) on the electronic device may affect the determination of the skin temperature. Thus, the actual skin temperature may differ from the calculated skin temperature (based on a 25° C. decline from the sensed temperature).

Embodiments may provide a means for a user to provide a scalar input value in order to alter a thermal threshold. As one example, the scalar input value may be used to alter the skin temperature threshold. For example, a user may provide a scalar input value in increments, such as increments of 0.25° C., increments of 0.5° C., and increments of 1° C. Other increments may also be used.

A maximum scalar input range (or maximum scalar value range) may be previously determined such that the user may only adjust a certain amount of the original thermal threshold. The scalar input range may correspond to a maximum amount of the original thermal threshold that may be changed. For example, the scalar input range may be a maximum range for a skin temperature threshold. As one example relating to a skin thermal threshold (or skin temperature threshold), a scalar input range for a skin thermal threshold may be −2° C. to +2° C. As another example, the scalar input range for skin thermal threshold may be 0 to +5° C.

An OEM (or other manufacturer) may select the scalar input range (or scalar value range) based on an assumed risk. The end user may not know temperatures, skin limits and other technical concepts. The end user may need a simple-to-answer question, such as “On a scale of 1 to 10, indicate how warm your device feels to you now (1 being cold, 5 being moderate, 10 being hot).” The OEM may choose the range for these scalar inputs such that a limited range of flexibility to the final skin threshold limit is used without selecting a value that ends up causing the electronic device to overheat or burn. The scalar input range may be stored as part of the thermal management operations implemented in Basic Input/Output System (BIOS) code or in hardware (HW) memory, etc.

A user may provide an input (i.e., thermal rating information) to adjust a thermal threshold. The amount of adjustment of the thermal threshold may be based on the thermal rating information and the scalar input range (i.e., the user input). More specifically, the thermal rating information may be used to determine a specific amount of adjustment based on the previously-stored scalar input range.

The thermal rating information may be requested in response to determination of a specific activity or operation of the electronic device. For example, the electronic device may monitor activities or operations of the electronic device, and may determine when a specific activity or operation has occurred. The electronic device may then allow the user to provide thermal rating information. The activity may relate to utilization, power draw, thermal threshold cross and thermal management actions. Additionally, the activity may relate to a specific application being run by the user or a specific application that finishes running, etc. As one example, the specific activity may be a time point right when a user exits a game or exits a movie playback.

Upon detection of the specific activity or operation, a user may be appropriately notified by the electronic device. The notification may be an audio notification, a video notification or a haptic notification. As will be described below, the user may then input appropriate thermal rating information.

Embodiments may allow a user to select a specific scalar rating value. The scalar rating value is a specific number within a scalar value range. For example, the scalar value range may be 0, 1, 2, . . . , 9, 10. The user may select a specific number from within the range. The selected value may be called a scalar input value.

The scalar value range may define the range in which the thermal threshold may be adjusted. The thermal management operation (or system) may provide (or generate) the scalar input value based on the scalar value range.

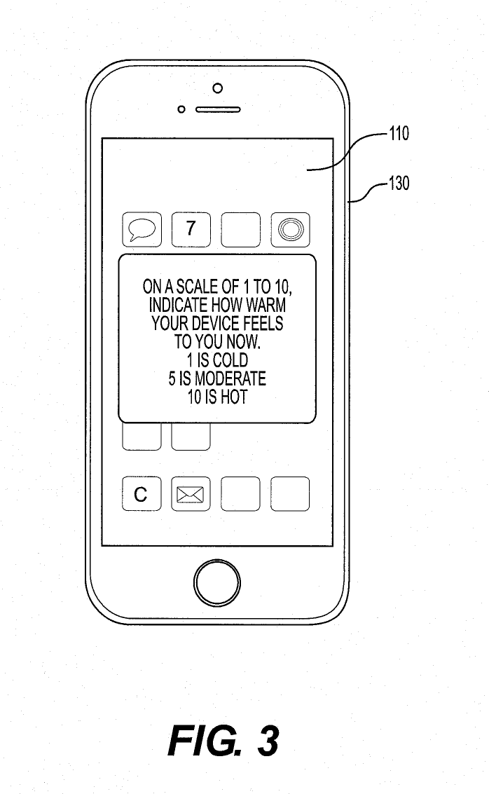

FIG. 3 shows an electronic device that displays a request for thermal rating information according to an example embodiment. Other embodiments may also be provided.

More specifically, FIG. 3 shows the display 110 displaying a request after the electronic device detects the specific activity or operation. The request may be a request for thermal rating information. The request may relate to user comfort.

FIG. 3 shows the display “On a scale of 1 to 10, indicate how warm your device feels to you now (1 being cold, 5 being moderate, 10 being hot).” Other requests or types of requests may also be provided.

Based on the displayed request, the user may input a specific rating value based on their own comfort level. In this example, the specific rating value may be a scalar number within a scalar value range of 0 to 10. The specific rating value may be provided from the user by an input at a key, an input at a touchscreen and/or an input by a button, for example. Other methods of providing a specific rating value may also be used. The specific rating value may be a scalar number within the scalar value range of 0 to 10, for example. The electronic device 100 may then calculate or determine an adjusted thermal threshold based on the specific rating value (i.e., the user input relating to the thermal rating information).

In order to calculate or determine the adjusted thermal threshold, the specific rating information may be mapped to the specific scalar value range. For example, if the user inputs a specific rating value of 10 (representing hot) and the scalar value range is −2 to +2, then the specific rating value of 10 may become a scalar input value of +2. The adjusted thermal threshold may then be calculated as follows:

Adjusted Thermal Threshold=Design Thermal Threshold−Scalar Input Value

Using the above formula, the adjusted thermal threshold may be determined as 68° C. based on the calculation of: 70−(+2)=68. The value of 68° C. may therefore become the adjusted thermal threshold (or adjusted threshold limit). This may cause the thermal management operations to perform various operations based on the adjusted thermal threshold. This may prevent the temperature from becoming too hot for the user.

As another example, if the user inputs a specific rating value of 0 (representing cold) and the scalar value range is −2 to +2, then the specific rating input value of 0 becomes a scalar input value of −2. Using the above formula, the adjusted thermal threshold may be determined as 72° C. (based on the calculation of 70−(−2)=72).

The increased temperature threshold may be based on the protective case being provided around the electronic device that makes the electronic device feel cold. Accordingly, the electronic device may be allowed to run at higher workload levels for a longer time and/or the electronic device may reach higher temperatures before performance of the electronic device performance may be reduced. The electronic device may run more efficiently based on the adjusted value while still operating within the specific user comfort level. This may differ from the OEM's original concept of a random users' comfort level.

A thermal rating application may be provided on the electronic device to allow the user to input thermal rating information. The thermal rating application may be executed whenever the user wants to change their thermal rating. A specific rating value may be used until the user specifically changes the thermal rating information. The thermal rating application may also provide configurable options for the user to select. These ratings may relate to the application proactively notifying the user to update the rating. The rating application may be on whenever a user desires upon detection of a specific activity (as discussed above).

In at least one embodiment, the user may input thermal rating information. The thermal rating information may be used to obtain the adjusted thermal threshold. In at least one embodiment, the adjusted thermal threshold may be maintained indefinitely until the thermal rating application is performed again (which may result in a new adjusted thermal threshold). For example, the thermal threshold may be changed during another iteration of the thermal rating application.

In at least one embodiment, during another iteration of the thermal rating application, the thermal threshold may be adjusted from the original design thermal threshold.

In at least one embodiment, during another iteration of the thermal rating application, the thermal threshold may be adjusted from the previous adjusted thermal threshold. In this embodiment, the previous thermal threshold may be considered a new design thermal threshold.

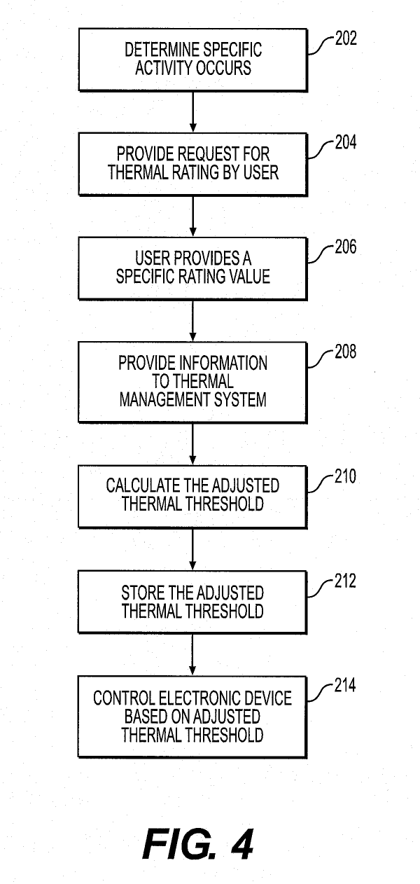

FIG. 4 is a flowchart of operations according to an example embodiment. Other operations, orders of operations and embodiments may also be provided. The operations described with respect to FIG. 4 may be performed at the electronic device.

In operation 202, the electronic device may determine that a specific activity (or operation) has occurred. This may trigger the electronic device to provide a request for a thermal rating by a user, in operation 204. As one example, the request may be displayed on the display. Other types of requests or notifications may also be provided.

In operation 206, the user may provide a specific rating value. The specific rating value may correspond to a user comfort level, for example. In at least one embodiment, the specific rating value may be a scalar number (or value) from 0 to 10.

In operation 208, information may be provided to the thermal management system, which may include the processor that performs the thermal management operations. The information that is provided may be the specific rating value that is input by the user. The user selected scalar number (or value) may be provided to the thermal management system to apply the correction/adjustment.

In operation 210, the adjusted thermal threshold is calculated (or determined) based on the information.

The adjusted thermal threshold may be stored in operation 212. For example, the adjusted thermal threshold may be stored in memory.

In operation 214, performance of the electronic device may be controlled based on the adjusted thermal threshold. The electronic device may perform thermal management of the electronic device using the adjusted thermal threshold. For example, the electronic device may detect that a specific parameter (i.e., a temperature) exceeds the adjusted thermal threshold. The electronic device may perform thermal management based on the detected parameter. This may include turning on an electronic component of the electronic device or changing performance of at least one electronic component of the electronic device.

FIG. 5 is a diagram of an electronic system according to an example embodiment, Other embodiments may also be provided.

FIG. 5 shows a system 400 that may include various elements or components. For example, FIG. 5 shows that the system 400 may include a processor 402, a chipset 404, an input/output (I/O) device 406, a random access memory (RAM) (such as dynamic RAM (DRAM)) 408, and a read only memory (ROM) 410, and various platform components 414 (e.g., a fan, a crossflow blower, a heat sink, DTM system, cooling system, housing, vents, and so forth). These elements may be implemented in hardware, software, firmware, or any combination thereof. The embodiments, however, are not limited to these elements.

As shown in FIG. 5, I/O device 406, RAM 408, and ROM 410 are coupled to the processor 402 by way of the chipset 404. The chipset 404 may be coupled to the processor 402 by a bus 412. Accordingly, the bus 412 may include multiple lines.

The processor 402 may be a central processing unit comprising one or more processor cores and may include any number of processors having any number of processor cores. The processor 402 may include any type of processing unit, such as, for example, CPU, multi-processing unit, a reduced instruction set computer (RISC), a processor that have a pipeline, a complex instruction set computer (CISC), digital signal processor (DSP), and so forth.

The system 400 may include various interface circuits, such as an Ethernet interface and/or a Universal Serial Bus (USB) interface, and/or the like. In some exemplary embodiments, the I/O device 406 may comprise one or more input devices connected to interface circuits for entering data and commands into the system 400. For example, the input devices may include a keyboard (physical or virtual/soft), mouse, touch screen, track pad, track ball, isopoint, a voice recognition system, and/or the like. Similarly, the I/O device 406 may comprise one or more output devices connected to the interface circuits for outputting information to an operator. For example, the output devices may include one or more displays, printers, speakers, and/or other output devices, if desired. For example, one of the output devices may be a display. The display may be a cathode ray tube (CRTs), liquid crystal displays (LCDs), or any other type of display.

The system 400 may also have a wired or wireless network interface to exchange data with other devices via a connection to a network. The network connection may be any type of network connection, such as an Ethernet connection, digital subscriber line (DSL), telephone line, coaxial cable, etc. The network may be any type of network, such as the Internet, a telephone network, a cable network, a wireless network, a packet-switched network, a circuit-switched network, and/or the like.

The following examples pertain to further embodiments.

Example 1 is a method of an electronic device comprising: receiving thermal rating information; determining an adjusted thermal threshold based on a previous thermal threshold and the thermal rating information; and controlling performance of the electronic device based on the adjusted thermal threshold.

In Example 2, the subject matter of Example 1 can optionally include detecting that a parameter exceeds the adjusted thermal threshold.

In Example 3, the subject matter of Examples 1 and 2 can optionally include the parameter is a temperature at the electronic device.

In Example 4, the subject matter of any one of Examples 1-3 can optionally include controlling performance of the electronic device includes performing thermal management based on the detected parameter.

In Example 5, the subject matter of Example 1 and Example 4 can optionally include performing thermal management includes turning on an electronic component of the electronic device.

In Example 6, the subject matter of Example 1 and Example 4 can optionally include performing thermal management includes changing performance of at least one electrical component of the electronic device.

In Example 7, the subject matter of Example 1 can optionally include displaying a request for the thermal rating information.

In Example 8, the subject matter of Example 1 can optionally include receiving thermal rating information includes receiving a scalar rating value.

In Example 9, the subject matter of any one of Examples 1-8 can optionally include determining the adjusted thermal threshold includes determining a scalar input value based on the user input.

In Example 10, the subject matter of Example 1 and Example 9 can optionally include determining the scalar input value is based on a scalar input range and the user input.

In Example 11, the subject matter of Example 1 can optionally include receiving another thermal rating information; determining another adjusted thermal threshold based on the adjusted thermal threshold and the another thermal rating information; and controlling performance of the electronic device based on the another adjusted thermal threshold.

In Example 12, the subject matter of Example 1 can optionally include receiving another thermal rating information; determining another adjusted thermal threshold based on the original thermal threshold and the another thermal rating information; and controlling performance of the electronic device based on the another adjusted thermal threshold.

Example 13 is an electronic device comprising: a display to display a request for thermal rating information, and the display to receive a user input relating to the thermal rating information; and a processor to determine an adjusted thermal threshold based on a previous thermal threshold and the user input relating to the thermal rating information, and the processor to control performance of the electronic device based on the adjusted thermal threshold.

In Example 14, the subject matter of Example 13 can optionally include the processor to detect that a parameter exceeds the adjusted thermal threshold.

In Example 15, the subject matter of Example 13 and Example 14 can optionally include the parameter is a temperature at the electronic device.

In Example 16, the subject matter of Example 13 and Examples 14-15 can optionally include the processor to perform thermal management based on the detected parameter.

In Example 17, the subject matter of Example 13 and Example 16 can optionally include the processor to perform thermal management by turning on an electronic component of the electronic device.

In Example 18, the subject matter of Example 13 and Example 16 can optionally include the processor to perform thermal management by changing performance of at least one electrical component of the electronic device.

In Example 19, the subject matter of any one of Examples 13-18 can optionally include the processor to determine the adjusted thermal threshold by determining a scalar input value based on the received user input relating to the thermal rating information.

In Example 20, the subject matter of Example 13 and Example 19 can optionally include the processor to determine the scalar input value based on a scalar input range and the user input.

In Example 21, the subject matter of Example 13 can optionally include the display to receive another user input relating to another thermal rating information, and the processor to determine another adjusted thermal threshold based on the adjusted thermal threshold and the another thermal rating information, and the processor to control performance of the electronic device based on the another adjusted thermal threshold.

In Example 22, the subject matter of Example 13 can optionally include the display to receive another user input relating to another thermal rating information, and the processor to determine another adjusted thermal threshold based on the original thermal threshold and the another thermal rating information, and the processor to control performance of the electronic device based on the another adjusted thermal threshold.

Example 23 is an electronic device comprising: first means for receiving a user input relating to thermal rating information; second means for determining an adjusted thermal threshold based on a previous thermal threshold and the user input relating to the thermal rating information; and third means for controlling performance of the electronic device based on the adjusted thermal threshold.

In Example 24, the subject matter of Example 23 can optionally include fourth means for detecting that a parameter exceeds the adjusted thermal threshold.

In Example 25, the subject matter of Example 23 and Example 24 can optionally include the parameter is a temperature at the electronic device.

In Example 26, the subject matter of any one of Examples 23-25 can optionally include the third means for performing thermal management based on the detected parameter.

In Example 27, the subject matter of Example 23 and Example 26 can optionally include the fourth means for performing thermal management by turning on an electronic component of the electronic device.

In Example 28, the subject matter of Example 23 and Example 26 can optionally include the fourth means for performing thermal management by changing performance of at least one electrical component of the electronic device.

In Example 29, the subject matter of any one of Examples 23-28 can optionally include the second means for determining the adjusted thermal threshold by determining a scalar input value based on the received user input relating to the thermal rating information.

In Example 30, the subject matter of Example 23 and Example 29 can optionally include the second means for determining the scalar input number based on a scalar input range and the user input relating to the thermal rating information.

In Example 31, the subject matter of Example 23 can optionally include the first means for receiving another thermal rating information; the second means for determining another adjusted thermal threshold based on the adjusted thermal threshold and the another thermal rating information; and the third means for controlling performance of the electronic device based on the another adjusted thermal threshold.

In Example 32, the subject matter of Example 23 can optionally include the first means for receiving another thermal rating information; the second means for determining another adjusted thermal threshold based on the original thermal threshold and the another thermal rating information; and the third means for controlling performance of the electronic device based on the another adjusted thermal threshold.

Example 33 is a machine-readable medium comprising one or more instructions that when executed cause a processor to perform one or more operations to: determine an adjusted thermal threshold based on a previous thermal threshold and a user input related to the thermal rating information; and control performance of the electronic device based on the adjusted thermal threshold.

In Example 34, the subject matter of Example 33 can optionally include the one or more operations further to detect that a parameter exceeds the adjusted thermal threshold.

In Example 35, the subject matter of Example 33 and Example 34 can optionally include the parameter is a temperature at the electronic device.

In Example 36, the subject matter of Example 33 and any one of Examples 34-35 can optionally include to control performance includes to perform thermal management based on the detected parameter.

In Example 37, the subject matter of Example 33 and Example 36 can optionally include to perform thermal management includes turning on an electronic component of the electronic device.

In Example 38, the subject matter of Example 33 and Example 36 can optionally include to perform thermal management includes changing performance of at least one electrical component of the electronic device.

In Example 39, the subject matter of any one of Examples 33-38 can optionally include to determine the adjusted thermal threshold includes to determine a scalar input value based on the received user input relating to the thermal rating information.

In Example 40, the subject matter of Example 33 and Example 39 can optionally include the scalar input value to be determined based on a scalar input range and the user input related to the thermal rating information.

In Example 41, the subject matter of Example 33 can optionally include the one or more operations to: receive another thermal rating information; determine another adjusted thermal threshold based on the adjusted thermal threshold and the another thermal rating information; and control performance of the electronic device based on the another adjusted thermal threshold.

In Example 42, the subject matter of Example 33 can optionally include the one or more operations to: receive another thermal rating information; determine another adjusted thermal threshold based on the original thermal threshold and the another thermal rating information; and control performance of the electronic device based on the another adjusted thermal threshold.

Example 43 is an apparatus comprising: first logic, at least a portion of which is in hardware, to determine an adjusted thermal threshold based on a previous thermal threshold and a user input relating to the thermal rating information; and second logic, at least a portion of which is in hardware, to control performance of the electronic device based on the adjusted thermal threshold.

In Example 44, the subject matter of Example 43 can optionally include the second logic to detect that a parameter exceeds the adjusted thermal threshold.

In Example 45, the subject matter of Example 43 and Example 44 can optionally include the parameter is a temperature at the apparatus.

In Example 46, the subject matter of Example 43 and any one of Examples 44-45 can optionally include the second logic to perform thermal management based on the detected parameter.

In Example 47, the subject matter of Example 43 and Example 46 can optionally include the second logic to perform thermal management by turning on an electronic component of the apparatus.

In Example 48, the subject matter of Example 43 and Example 46 can optionally include the second logic to perform thermal management by changing performance of at least one electrical component of the apparatus.

In Example 49, the subject matter of any one of Examples 43-48 can optionally include the second logic to determine the adjusted thermal threshold by determining a scalar input value based on the received user input relating to the thermal rating information.

In Example 50, the subject matter of Example 43 can optionally include the second logic to determine the scalar input value based on a scalar input range and the user input relating to the thermal rating information.

In Example 51, the subject matter of Example 43 can optionally include the first logic to determine another adjusted thermal threshold based on the adjusted thermal threshold and another thermal rating information; and the second logic to control performance of the electronic device based on the another adjusted thermal threshold.

In Example 52, the subject matter of Example 43 can optionally include the first logic to determine another adjusted thermal threshold based on the original thermal threshold and another thermal rating information; and the second logic to control performance of the electronic device based on the another adjusted thermal threshold.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of an electronic device comprising:
receiving thermal rating information;
determining an adjusted thermal threshold based on a previous thermal threshold and the thermal rating information; and
controlling performance of the electronic device based on the adjusted thermal threshold.

2. The method of claim 1, further comprising:
detecting that a parameter exceeds the adjusted thermal threshold.

3. The method of claim 2, wherein the parameter is a temperature at the electronic device.

4. The method of claim 2, wherein controlling performance includes turning on an electronic component of the electronic device based on the detected parameter.

5. The method of claim 2, wherein controlling performance includes changing performance of at least one electrical component of the electronic device based on the detected parameter.

6. The method of claim 1, wherein receiving thermal rating information includes receiving a scalar rating value.

7. The method of claim 1, wherein determining the adjusted thermal threshold includes determining a scalar input value based on the user input.

8. The method of claim 1, further comprising:
receiving another thermal rating information;
determining another adjusted thermal threshold based on the adjusted thermal threshold and the another thermal rating information; and
controlling performance of the electronic device based on the another adjusted thermal threshold.

9. The method of claim 1, further comprising:
receiving another thermal rating information;
determining another adjusted thermal threshold based on the original thermal threshold and the another thermal rating information; and
controlling performance of the electronic device based on the another adjusted thermal threshold.

10. An electronic device comprising:
a display to display a request for thermal rating information, and the display to receive a user input relating to the thermal rating information; and
a processor to determine an adjusted thermal threshold based on a previous thermal threshold and the user input relating to the thermal rating information, and the processor to control performance of the electronic device based on the adjusted thermal threshold.

11. The electronic device of claim 10, wherein the processor to detect that a parameter exceeds the adjusted thermal threshold.

12. The electronic device of claim 11, wherein the parameter is a temperature at the electronic device.

13. The electronic device of claim 11, wherein the processor to control performance by turning on an electronic component of the electronic device based on the detected parameter.

14. The electronic device of claim 11, wherein the processor to control performance by changing performance of at least one electrical component of the electronic device based on the detected parameter.

15. The electronic device of claim 10, wherein the display to receive another user input relating to another thermal rating information, and the processor to determine another adjusted thermal threshold based on the adjusted thermal threshold and the another thermal rating information, and the processor to control performance of the electronic device based on the another adjusted thermal threshold.

16. The electronic device of claim 10, wherein the display to receive another user input relating to another thermal rating information, and the processor to determine another adjusted thermal threshold based on the original thermal threshold and the another thermal rating information, and the processor to control performance of the electronic device based on the another adjusted thermal threshold.

17. A machine-readable medium comprising one or more instructions that when executed cause a processor to perform one or more operations to:
determine an adjusted thermal threshold based on a previous thermal threshold and a user input related to the thermal rating information; and
control performance of the electronic device based on the adjusted thermal threshold.

18. The machine-readable medium of claim 17, wherein the one or more operations further to detect that a parameter exceeds the adjusted thermal threshold.

19. The machine-readable medium of claim 17, wherein controlling performance includes turning on an electronic component of the electronic device.

20. The machine-readable medium of claim 17, wherein controlling performance includes changing performance of at least one electrical component of the electronic device.
